(19) United States
(12) Patent Application Publication
(10) Pub. No.: US 2026/0184931 A1
(43) Pub. Date: Jul. 2, 2026

(54) FLUORESCENCE-ENABLED COLORED BILAYER SUB-AMBIENT RADIATIVE COOLING COATINGS

(71) Applicant: City University of Hong Kong, Hong Kong (HK)

(72) Inventors: Dangyuan LEI, Hong Kong (HK); Xue MA, Hong Kong (HK); Ying LIU, Hong Kong (HK)

(21) Appl. No.: 19/006,259

(22) Filed: Dec. 31, 2024

(51) Int. Cl. C09D 5/33; C09D 5/22; C09D 7/40; C09D 7/61; C09K 11/77

(52) U.S. Cl. CPC C09D 5/004; C09D 5/22; C09D 7/61; C09D 7/67; C09D 7/69; C09D 7/70; C09K 11/7734; C09K 11/77342; C09K 11/77347

(57) ABSTRACT

A colored bilayer sub-ambient radiative cooling coating designed to enhance solar reflectance and aesthetic coloration is introduced. The coating includes a white bottom layer containing TiO₂ or ZrO₂ nanoparticles, and hollow glass spheres dispersed in a polymer matrix, and a colored top layer containing SiO₂ microspheres and fluorescent pigments selected from Sr₂Si₅N₈:Eu²⁺, Y₃A₁₅O₁₂:Ce³⁺, (Ba,Sr)SiO₄:Eu²⁺, or SrO·Al₂O₃:Eu phosphors dispersed in a polymer matrix. This bilayer structure achieves an effective solar reflectance of at least 90% and reduces surface temperature by at least 3° C. compared to ambient air, providing energy-efficient cooling with aesthetic appeal.

### FIELD OF THE INVENTION

The present invention generally relates to thermal management technologies and specifically relates to passive radiative cooling mechanisms. More specifically the present invention relates to colored bilayer sub-ambient radiative cooling coatings.

### BACKGROUND OF THE INVENTION

Cooling enclosed spaces such as buildings and vehicles is critical for maintaining human thermal comfort. However, traditional vapor compression-based cooling technologies are energy-intensive and environmentally detrimental, contributing to the global energy crisis and exacerbating climate change. These systems consume massive amounts of energy and emit greenhouse gases, motivating the search for alternative, energy-efficient cooling technologies. Recently, passive daytime radiative cooling has garnered significant global attention due to its potential to achieve space cooling without energy consumption or greenhouse gas emissions. This innovative approach leverages the extremely low blackbody radiation temperature of outer space (˜2.7 K) as a heat sink. By employing radiative cooling surfaces with high emissivity in the atmospheric transparency window (8-13 μm) and low absorptivity in the solar spectrum (0.3-2.5 μm), terrestrial objects (˜300 K) can dissipate heat through infrared thermal radiation, achieving sub-ambient cooling even under direct sunlight.

Various materials and structures, including multilayered photonic structures, metamaterials, porous structures, and polymer-dielectric composites, have been explored to enhance the efficiency of radiative cooling. Among these, polymer-dielectric composites are particularly promising due to their low cost, scalability, and high cooling efficiency, making them suitable for real-world applications. These composites typically consist of a polymer matrix (e.g., PMMA, PDMS, TPX) with dielectric fillers (e.g., TiO₂, Al₂O₃, SiO₂, BaSO₄), which provide high solar reflectance and thermal radiation. However, traditional white cooling coatings that rely on multiple Mie scattering for solar reflectance often appear visually overwhelming and lack aesthetic appeal.

To address these limitations, researchers have investigated colored radiative cooling coatings to meet aesthetic demands while mitigating light pollution. Conventional color pigments, which rely on reflected visible light for coloration, can absorb significant solar energy, converting it into non-radiative heat and compromising cooling efficiency. Since visible light accounts for nearly half of the solar spectrum (˜500 W/m²), pigments often create a trade-off between color saturation and cooling performance. Structural coloration, achieved through optimized photonic structures such as multilayer films or periodic micro/nanostructures, offers an alternative by minimizing light absorption. However, these techniques typically require sophisticated, equipment-intensive manufacturing processes, limiting their scalability and cost-effectiveness.

An emerging approach to overcoming these challenges involves incorporating fluorescent materials into radiative cooling coatings. Fluorescent materials re-emit absorbed light as photons with longer wavelengths, reducing solar heating while maintaining vibrant coloration. This method is compatible with polymer-dielectric composites and existing coating manufacturing processes, offering a cost-effective solution for large-scale applications. Fluorescent-assisted cooling coatings have demonstrated versatile colors, such as yellow, green, and red, with sub-ambient cooling performance. However, challenges remain in optimizing photoluminescent properties, including photoluminescence quantum yield (PLQY), Stokes shift, and emission spectra, to achieve efficient cooling under peak solar irradiation. Notably, producing blue coatings remains difficult due to the need to absorb a larger portion of visible light, limiting the full-spectrum coloration potential.

Promising fluorescent materials for colored cooling coatings include perovskite nanocrystals and rare-earth ion-doped phosphors. Perovskite nanocrystals exhibit high PLQY but face long-term stability issues due to sensitivity to water and oxygen, along with environmental concerns over lead toxicity. Rare-earth ion-doped phosphors offer high PLQY, strong resistance to degradation in water-based polymer matrices, and excellent color rendition, making them viable alternatives. Additionally, the Purcell effect, achieved by embedding fluorescent pigments into polymer-dielectric composites with Mie resonances, can further enhance cooling efficiency. By modifying the local dielectric environment, the Purcell effect shortens photoluminescence lifetime, increasing the intensity of re-emitted photons and improving effective solar reflectance. While this effect has primarily been demonstrated in white cooling coatings using UV light, its potential for enhancing visible-light-driven fluorescent cooling coatings remains underexplored.

Therefore, the present invention addresses this need and explores the potential of Purcell-enhanced fluorescence to advance colored radiative cooling technologies for practical implementation.

### SUMMARY OF THE INVENTION

It is an objective of the present invention to provide compound, material, or method to solve the aforementioned technical problems.

In accordance with a first aspect of the present invention, a colored bilayer sub-ambient radiative cooling coating is provided for improving solar reflectance and coloration. Particularly, the coating includes:
a white bottom layer, including TiO₂ or ZrO₂ nanoparticles, and hollow glass spheres; and
a colored top layer positioned on the white bottom layer, comprising SiO₂ micropheres and fluorescent pigments selected from Sr₂Si₅N₈:Eu²⁺, Y₃A₁₅O₁₂:Ce³⁺, (Ba,Sr)SiO₄:Eu²⁺, or SrO·Al₂O₃:Eu phosphors.

In accordance with one embodiment of the present invention, the colored bilayer sub-ambient radiative cooling coating achieve an effective solar reflectance of at least 90% and a sub-ambient temperature reduction of at least 3° C. compared to ambient air.

In accordance with one embodiment of the present invention, the white bottom layer and the colored top layer include a polymer matrix material selected from one or more of poly(styrene-acrylic), poly(methyl methacrylate), poly(vinylidene fluoride), poly(ethylene-co-vinyl acetate), or polycarbonate.

In accordance with one embodiment of the present invention, the nanoparticles are the TiO₂ nanoparticles when the fluorescent pigments are the Sr₂Si₅N₈:Eu²⁺ phosphors, Y₃Al₅O₁₂:Ce³⁺ phosphors, or (Ba,Sr)SiO₄:Eu²⁺ phosphors.

In accordance with another embodiment of the present invention, the nanoparticles are the ZrO₂ nanoparticles when the fluorescent pigments are the SrO·Al₂O₃:Eu phosphors.

In accordance with one embodiment of the present invention, the TiO₂ or ZrO₂ nanoparticles in the white bottom layer, may be replaced by other high refractive index and large bandgap dielectric nanoparticles, including but not limited to boron nitride, silicon nitride, zinc oxide, calcium carbonate, barium sulfate, silicon dioxide, that can strongly scatter incident sunlight.

In accordance with one embodiment of the present invention, the SiO₂ microspheres in the top-colored layer have diameters ranging from 2 μm to 10 μm to optimize light scattering across the visible spectrum.

In accordance with one embodiment of the present invention, the top layer has a thickness of 20 to 40 μm to balance color intensity and minimize solar absorption.

In accordance with one embodiment of the present invention, the white bottom layer has a thickness of 300 to 900 μm.

In accordance with one embodiment of the present invention, the fluorescent pigments exhibit a photoluminescence quantum yield (PLQY) of larger than 50% under direct sunlight exposure.

In accordance with one embodiment of the present invention, the coating is configured to provide a cooling power of at least 38 W/m² under peak solar intensity.

In accordance with one embodiment of the present invention, the white bottom layer achieves a solar reflectance of at least 95% independently of the colored top layer.

In accordance with a second aspect of the present invention, a method of fabricating the aforementioned colored bilayer sub-ambient radiative cooling coating on a substrate. Specifically, the method includes the following steps:
preparing a white bottom layer by dispersing TiO₂ or ZrO₂ nanoparticles and hollow glass spheres in a polymer matrix;
depositing the white bottom layer onto a substrate;
preparing a colored top layer by incorporating fluorescent pigments and SiO₂ microspheres into a polymer matrix; and
layering the colored top layer onto the white bottom layer to form the bilayer coating.

In accordance with one embodiment of the present invention, the fluorescent pigments includes one or more of Sr₂Si₅N₈:Eu²⁺, Y₃A₁₅O₁₂:Ce³⁺, (Ba,Sr)SiO₄:Eu²⁺, or SrO·Al₂O₃:Eu phosphors.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

Embodiments of the invention are described in more details hereinafter with reference to the drawings, in which:

FIG. 1A-1B depict schematics of the colored bilayer structure with a white bottom layer and a top-colored layer, in which FIG. 1A illustrates the functions of the coating and FIG. 1B depicts the structure of the coating;

FIG. 2A-2C depict the excitation and emission spectra of different fluorescent materials, in which FIG. 2A relates to a red phosphor, FIG. 2B corresponds to a yellow phosphor, and FIG. 2C depicts a green phosphor;

FIG. 3A-3C depict the lattice structures and energy transfer pathways, in which FIG. 3A is a schematic of the lattice structures of Sr₂Si₅N₈ (CIF: mp-9710), FIG. 3B is a schematic of the lattice structures of (Ba,Sr)SiO₄ (CIF: mp-18510), and

FIG. 3C displays the energy transfer pathways in Eu²⁺: 4f⁶5d¹ with Eu²⁺ occupied at different Sr²⁺ sites;

FIG. 4A-4B depict the crystal structure and energy transfer mechanism, in which FIG. 4A is a schematic of the lattice structure of Y₃Al₅O₁₂ (CIF: mp-3050) and FIG. 4B is a schematic of electronic transitions in Ce³⁺;

FIG. 5A-5F depict the impacts of surrounding SiO₂ microspheres on the PL behaviors in the coating, in which FIG. 5A depicts the simulated scattering efficiencies of SiO₂ microspheres with varied diameter in the polymer matrix, FIG. 5B shows the electric field distribution profiles in the same SiO₂ microspheres at λ=525 nm, 560 nm, and 650 nm as marked in FIG. 5A, FIG. 5C displays the cross-sectional scanning electron microscope (SEM) images of colored coatings with SiO₂ microspheres of different diameters and phosphors of different colors, and FIG. 5D, FIG. 5E and FIG. 5F collectively demonstrates the PL lifetime spectra of pure phosphors and that in the red phosphor (FIG. 5D), yellow phosphor (FIG. 5E) and green phosphor (FIG. 5F) cooling coatings with SiO₂ microspheres at different diameters;

FIG. 6A-6I depict the effect of SiO₂ microspheres on the photoluminescence (PL) behavior within the coating, in which FIG. 6A-6C demonstrate the absorption spectra of the red (FIG. 6A), yellow (FIG. 6B) and green (FIG. 6C) phosphors in the coatings with or without SiO₂ microspheres, FIG. 6D-6I show the corresponding PL quantum yields (FIGS. 6D-6F) and power yield (FIG. 6G-6I) of the three phosphors;

FIG. 7A-7B depict the field test results, in which FIG. 7A shows the recorded temperature curves of ambient air, a single-layer TiO₂ coating, a SiO₂/TiO₂ bilayer white coating, and three colored bilayer coatings, and FIG. 7B displays the calculated ESR of the colored bilayer coatings corresponding to SiO₂ microspheres with diameters of 5 μm;

FIG. 8A-8D depict the evaluation of ZrO₂ nanoparticles in the colored bilayer coatings, in which FIG. 8A presents the stimulated scattering efficiency map of ZrO₂ nanoparticles with varied diameters and solar intensity spectrum, FIG. 8B shows the reflectance spectra of coatings with ZrO₂ nanoparticles, FIG. 8C displays the Reflectance spectra of polymer coatings with varying ZrO₂ nanoparticles volume fractions, and FIG. 8C illustrates the reflectance spectra of ZrO₂ ultra white coatings with different thickness;

FIG. 9A-9B depict the characteristics of ZrO₂ nanoparticles, in which FIG. 9A shows the stimulated scattering spectra of ZrO₂ nanoparticles with varied diameters and solar intensity spectrum and FIG. 9B displays the size distribution of ZrO₂ nanoparticles monodispersed in water;

FIG. 10A-10D depict the optical and spectral properties of the blue bilayer [0034] sub-ambient radiative cooling coatings, in which FIG. 10A shows the excitation and emission spectra of SrO·Al₂O₃:Eu blue phosphor, FIG. 10B demonstrates the absorption and power yield spectra of the blue phosphor with (solid lines) and without (dashed lines) the ZrO₂ nanoparticles, FIG. 10C shows the reflectance spectra of bottom white coating and bilayer blue coatings with varied phosphor volume fractions and varied ZrO₂ nanoparticles concentrations, and FIG. 10D exhibits the optical images of the white base and blue bilayer coatings with varying phosphor concentrations; and

FIG. 11A-11B depict the field test results regarding the blue bilayer sub-ambient radiative cooling coatings, in which FIG. 11A demonstrates the recorded temperature curves of ambient air, a single-layer ZrO₂ coating, three bilayer blue coatings with the phosphor volume fraction of 5v %, 10v % and 15v %, along with solar intensity, and FIG. 11B shows the wind speed and humidity.

### DETAILED DESCRIPTION

In the following description, colored bilayer sub-ambient radiative cooling coating and the fabrication methods thereof and the likes are set forth as preferred examples. It will be apparent to those skilled in the art that modifications, including additions and/or substitutions may be made without departing from the scope and spirit of the invention. Specific details may be omitted so as not to obscure the invention; however, the disclosure is written to enable one skilled in the art to practice the teachings herein without undue experimentation.

Radiative cooling rises from the infrared radiation of terrestrial objects which can passively dissipate heat to the cold universe through the atmospheric transparent window. Sub-ambient cooling effect has been obtained for various materials and structures, either natural or artificial. Polymer coatings based on matrix-filler system exhibit great superiorities including cost effectiveness, ease in production and multiple functionalities, which are promising for the real-world applications of radiative cooling technologies.

In general, the fundamental thermal processes involved in a typical daytime radiative cooling device at temperature T can be grouped into four sources, as expressed in Equation (1) below.

$${P}_{cool} ( T ) = {P}_{rad} ( T ) - {P}_{sun} - {P}_{atm} - {P}_{cond + conv} \qquad ( 1 )$$

where P_{rad}(T), Pₛᵤₙ, and Pₐₜₘ are the outgoing thermal radiation power, absorbed solar irradiance, and absorbed atmospheric longwave radiation power by the device, respectively, and P_{cond+conv} is the received heat convection and conduction from the surrounding environment. For colored radiative cooling coatings, most colored pigments absorb visible light significantly and convert it to non-radiative thermal energy. Higher color saturation would increase Pₛᵤₙ and compromise the cooling effect. Regarding this issue, a fluorescent-assisted method has been proposed to reduce solar absorption and solve the dilemma of colored radiative cooling. Beyond the reflected sunlight as the counterparts of Pₛᵤₙ, fluorescent materials can introduce an additional light emission channel towards the atmosphere.

As used herein, the term “sub-ambient temperature” refers to a temperature that is lower than the surrounding ambient temperature of the environment. In the context of cooling technologies, such as passive radiative cooling, achieving sub-ambient temperature means that the object or surface being cooled is maintained at a temperature below the ambient air temperature without relying on active energy input like electricity.

This phenomenon typically occurs through processes such as infrared thermal emission, where heat is radiated away into the cold outer space via the atmospheric transparency window (8-13 μm), while minimizing heat absorption from solar radiation (0.3-2.5 μm). Achieving sub-ambient temperature is crucial for applications like energy-efficient building cooling, thermal management, and advanced material design.

As used herein, the term “green building” refers to a structure that is designed, constructed, and operated in a way that minimizes its environmental impact while promoting resource efficiency and occupant well-being. This concept integrates sustainable practices throughout the building's lifecycle, including site selection, design, construction, operation, maintenance, renovation, and demolition.

Green buildings typically incorporate features such as energy-efficient systems, renewable energy sources, water conservation methods, sustainable materials, improved indoor air quality, and waste reduction strategies. They aim to reduce greenhouse gas emissions, lower energy and water consumption, and promote a healthy and comfortable living or working environment. Green buildings often comply with certification programs, such as LEED (Leadership in Energy and Environmental Design), BREEAM (Building Research Establishment Environmental Assessment Method), or similar standards that assess and recognize sustainable building practices.

In accordance with a first aspect of the present invention, a colored bilayer sub-ambient radiative cooling coating is provided. The coating is designed to enhance solar reflectance and achieve visually appealing coloration while providing a cooling effect below ambient air temperature. This advanced coating system includes a dual-layer structure. The first layer, referred to as the white bottom layer, includes TiO₂ or ZrO₂ nanoparticles, and hollow glass spheres. This foundational layer ensures high solar reflectance and thermal emissivity by effectively scattering light across the solar spectrum. The second layer, positioned on top of the white bottom layer, is a colored top layer that integrates SiO₂ micropheres and fluorescent pigments. These pigments are selected from Sr₂Si₅N₈:Eu²⁺ phosphors for red coloration, Y₃Al₅O₁₂:Ce³⁺ phosphors for yellow, (Ba,Sr)SiO₄:Eu²⁺ phosphors for green, or SrO·Al₂O₃:Eu phosphors for blue. This bilayer system achieves an effective solar reflectance of at least 90% and provides a sub-ambient temperature reduction of at least 3° C. compared to the surrounding air.

The nanoparticles embedded in the coating are chosen from either TiO₂ or ZrO₂. The TiO₂ nanoparticles are specifically used when the fluorescent pigments are Sr₂Si₅N₈:Eu²⁺, Y₃Al₅O₁₂:Ce³⁺, or (Ba,Sr)SiO₄:Eu²⁺, as they contribute to optimal light scattering and high reflectance properties. Conversely, ZrO₂ nanoparticles are utilized when the fluorescent pigments are SrO·Al₂O₃:Eu. ZrO₂, with its high refractive index and wide band gap, ensures efficient light scattering, especially in the blue wavelength range, which is critical for achieving vibrant coloration without compromising solar reflectance.

In some embodiments, the TiO₂ or ZrO₂ nanoparticles used in the white bottom layer can be substituted or cooperated with other dielectric nanoparticles that possess a high refractive index and a wide bandgap. Suitable alternatives include, but are not limited to, boron nitride, silicon nitride, zinc oxide, calcium carbonate, barium sulfate, and silicon dioxide. These materials are capable of effectively scattering incident sunlight, ensuring the desired performance of the white bottom layer.

The bilayer structure employs a polymer matrix for both the white bottom and colored top layers. The polymer matrix material may include poly(styrene-acrylic), poly(methyl methacrylate), poly(vinylidene fluoride), poly(ethylene-co-vinyl acetate), or polycarbonate, selected for their thermal stability, durability, and compatibility with the integrated pigments and nanoparticles.

To further enhance the optical properties of the coating, the SiO₂ microspheres incorporated into the white bottom layer are specifically engineered with diameters ranging from 2 μm to 10 μm. This size range optimizes Mie scattering, enabling efficient light scattering across the visible spectrum and boosting solar reflectance.

In some embodiments, the top layer has a thickness of 20-40 μm to balance color intensity and minimize solar absorption, and the white bottom layer has a thickness of 300-900 μm.

The colored top layer is designed with a precisely controlled thickness to balance the desired color intensity with minimal solar absorption. The fluorescent pigments used in this layer exhibit a photoluminescence quantum yield (PLQY) of at least 50% under direct sunlight exposure. This high PLQY ensures that absorbed solar energy is re-emitted at longer wavelengths, reducing heat gain while maintaining vibrant coloration.

Additionally, the coating system is configured to provide a cooling power of at least 38 W/m² under peak solar intensity. The white bottom layer independently achieves a solar reflectance of at least 95%, ensuring its high-performance cooling capability regardless of the presence of the colored top layer.

This bilayer structure represents a significant advancement in radiative cooling technology, addressing the need for efficient, aesthetically pleasing, and environmentally friendly cooling solutions. The careful integration of material properties, such as nanoparticle composition, pigment photoluminescence, and layer design, ensures optimal performance in reducing solar heating while maintaining vibrant, customizable coloration.

The colored bilayer sub-ambient radiative cooling coating offers versatile applications in thermal management and energy-saving technologies. A key application lies in green building design, where the coating can significantly reduce the surface temperature of roofs and walls without relying on electricity, enhancing energy efficiency and prolonging the service life of building structures. The waterborne polymer matrix used in the coating emits zero volatile organic compounds, making it environmentally friendly and supportive of carbon neutrality objectives. Under direct sunlight, this cooling system provides passive cooling benefits, eliminating the need for electricity or cooling agents, making it ideal for infrastructure applications such as bridges, power plants, and roads.

Additionally, this fluorescence-assisted strategy can be adapted to other sectors requiring high solar reflectance. For instance, outdoor apparel can benefit from this technology by blocking intense solar radiation to improve human thermal comfort in hot conditions. Similarly, outdoor electronics, which generate heat during operation, can use the colored bilayer sub-ambient radiative cooling coating to maintain optimal temperatures during the day, ensuring stable performance and extended operational lifespans.

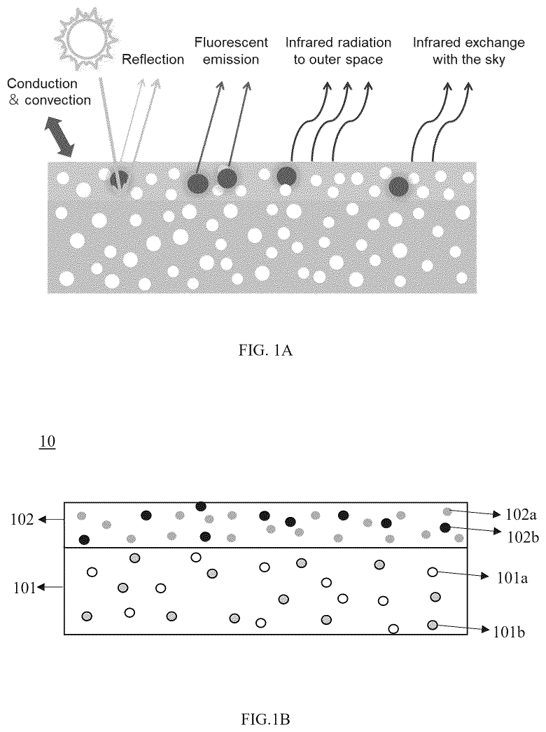

In accordance of one embodiment of the present invention, a fluorescence-enabled colored bilayer sub-ambient radiative cooling coating is introduced. The interactions between the fluorescence-enabled colored bilayer sub-ambient radiative cooling coating and the sunlight are depicted in FIG. 1A

Referring to FIG. 1B, the coating 10 includes a bilayer structure having a white bottom layer 101, and a colored top layer 102 positioned on the white bottom layer 101, which together enhance solar reflectance and achieve vibrant coloration. The white bottom layer 101 includes TiO₂ or ZrO₂ nanoparticles 101a and hollow glass spheres 101b; and the colored top layer 102 includes SiO₂ microspheres 102a and fluorescent pigments 102b.

Both layers are composed of a poly(styrene-acrylic) polymer matrix embedded with dielectric fillers. For red, yellow, and green radiative cooling coatings, the bottom layer incorporates white TiO₂ nanoparticles and hollow glass spheres to boost solar reflection and thermal emission. However, the inherent UV absorption of TiO₂ can limit UV reflectance. To address this limitation, SiO₂ microspheres are added to the top layer to efficiently scatter UV, visible, and near-infrared (NIR) light, with their scattering efficiency tuned by particle size. The top layer further incorporates phosphors such as Sr₂Si₅N₈:Eu²⁺ for red, Y₃Al₅O₁₂:Ce³⁺ for yellow, and (Ba,Sr)SiO₄:Eu²⁺ for green colors, respectively.

Achieving blue sub-ambient radiative cooling coatings presents additional challenges due to the need for higher absorption of visible light to achieve vivid coloration. For blue coatings, the top layer consists of a poly(styrene-acrylic) matrix blended with ZrO₂ nanoparticles. The high refractive index of ZrO₂ enhances scattering by leveraging the strong dielectric contrast with the polymer matrix. To balance vibrant coloration and high solar reflectance, a light-blue phosphor, SrO·Al₂O₃:Eu²⁺, is incorporated into an ultra-thin top layer, achieving the desired optical and cooling performance.

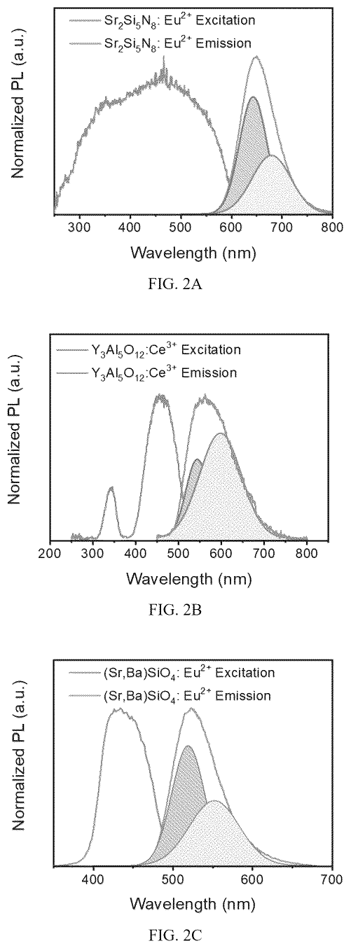

The invention employs three rare-earth doped phosphors as fluorescent materials: Sr₂Si₅N₈:Eu²⁺ for red, Y₃Al₅O₁₂:Ce³⁺ for yellow, and (Ba,Sr)SiO₄:Eu²⁺ for green coloration. Their excitation and emission spectra, shown in FIG. 2A-2C, demonstrate their ability to absorb both UV and visible light and emit light at longer wavelengths, reducing solar heat absorption while maintaining coloration. Notably, the emission spectra of these phosphors can be decomposed into two Lorentzian peaks, attributed to the atomic arrangement in the crystal structure.

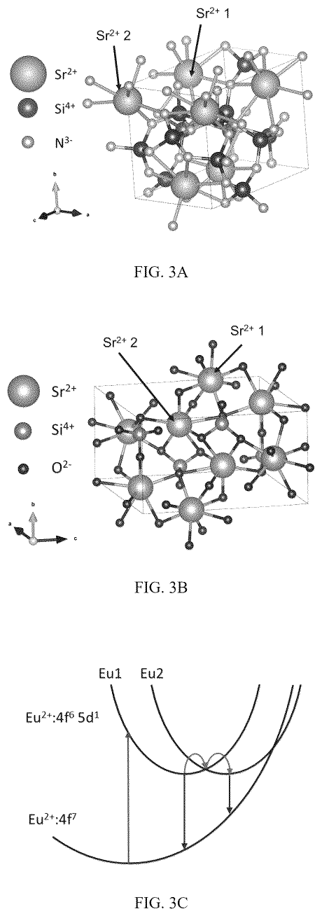

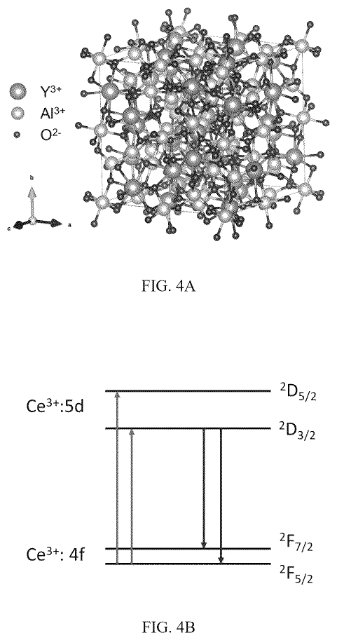

For Sr₂Si₅N₈:Eu²⁺ and (Ba,Sr)SiO₄:Eu²⁺, two distinct Sr²⁺ ion sites (Sr²⁺₁ and Sr²⁺₂), each experiencing different crystal field strengths, can be occupied by Eu²⁺ ions (Eu²⁺₁ and Eu²⁺₂). This occupancy leads to distinct energy levels for the excited state 4f⁶5d¹ of Eu²⁺, as depicted in FIG. 3A-3C. In the case of Y₃Al₅O₁₂:Ce³⁺, the Ce³⁺ ions, although experiencing the same crystal field strength, exhibit a two-peak photoluminescence emission. This is due to the splitting of the Ce³⁺ 4f state into two components (²F₅/₂ and ²F₇/₂) caused by spin-orbit interaction. The crystal structures and the energy transfer mechanisms underlying these phenomena are illustrated in FIGS. 4A and 4B, highlighting the intricate design of these phosphors for effective sub-ambient radiative cooling.

In accordance with a second aspect of the present invention, a method for fabricating a colored bilayer sub-ambient radiative cooling coating on a substrate is introduced. The fabrication begins with the preparation of the white bottom layer. This layer is created by uniformly dispersing nanoparticles, SiO₂ microspheres, and hollow glass spheres into a polymer matrix. The nanoparticles, selected from TiO₂ or ZrO₂ depending on the intended application and fluorescent pigments, serve as the primary scatterers to enhance solar reflectance. TiO₂ nanoparticles are particularly suitable for applications involving Sr₂Si₅N₈:Eu²⁺, Y₃Al₅O₁₂:Ce³⁺, or (Ba,Sr)SiO₄:Eu²⁺ phosphors, while ZrO₂ nanoparticles are chosen when the fluorescent pigments include SrO·Al₂O₃:Eu phosphors due to their superior scattering efficiency in the blue spectrum.

Once the dispersion is achieved, the white bottom layer is deposited onto the substrate. The deposition process ensures a uniform thickness, allowing the layer to provide maximum reflectance and form a stable base for the subsequent colored top layer. The choice of polymer matrix for this layer is critical, with materials such as poly(styrene-acrylic), poly(methyl methacrylate), poly(vinylidene fluoride), poly(ethylene-co-vinyl acetate), and polycarbonate being preferred for their thermal stability, durability, and compatibility with the integrated fillers.

The next step involves the preparation of the colored top layer. Fluorescent pigments, selected from Sr₂Si₅N₈:Eu²⁺, Y₃A₁₅O₁₂:Ce³⁺, (Ba,Sr)SiO₄:Eu²⁺, and SrO·Al₂O₃:Eu phosphors, are incorporated into another polymer matrix. These pigments are chosen based on the desired coloration, with their photoluminescence properties tailored to re-emit absorbed light at longer wavelengths, reducing heat gain and enhancing visual appeal. The pigment-polymer mixture is carefully formulated to ensure uniform dispersion and optimal optical performance.

Once prepared, the colored top layer is layered onto the white bottom layer to form the bilayer coating. This layering process is executed with precision to maintain the integrity of both layers, ensuring strong adhesion and minimal intermixing. The thickness of the top layer is controlled to balance color intensity and solar reflectance, with special attention to minimizing solar absorption while achieving the desired visual effects.

This method of fabrication results in a robust, high-performance bilayer coating that not only meets the aesthetic demands of various applications but also delivers effective sub-ambient cooling. The systematic integration of materials and careful layering ensure scalability and adaptability for use in a wide range of substrates and environments, making the invention suitable for green building designs, outdoor electronics, fabrics, and other thermal management applications.

### EXAMPLES

### Example 1. Enhancing Photoluminescence Efficiency Via SiO₂ Microspheres and the Purcell Effect in Radiative Cooling Coatings

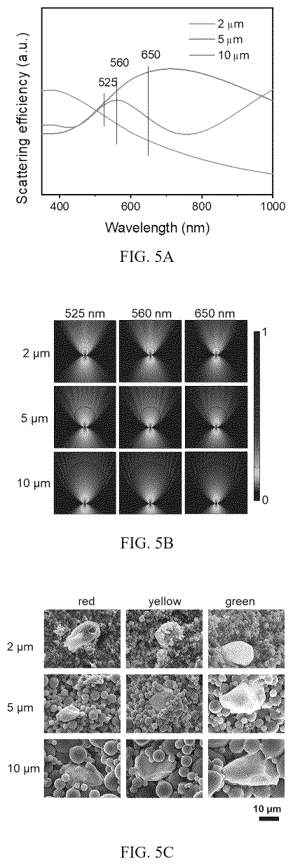

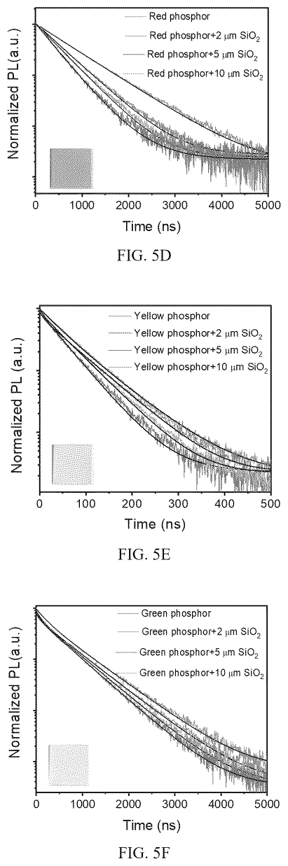

SiO₂ microspheres in the top layer play a crucial role in manipulating the photoluminescence (PL) emission of phosphors. Previous studies have shown that introducing phosphors into TiO₂-based coatings reduces their PL decay, indicating a Purcell effect within the coating system. However, due to the strong UV absorption and irregular geometry of TiO₂ nanoparticles, SiO₂ microspheres are selected as an alternative to achieve superior Mie resonance and local field modification, thereby enhancing the Purcell effect. Similar to TiO₂ nanoparticles, SiO₂ microspheres can scatter light across various wavelengths depending on their size. FIG. 5A illustrates the calculated scattering spectra of SiO₂ microspheres with diameters of 2 μm, 5 μm, and 10 μm embedded in a polymer matrix. Larger SiO₂ microspheres are observed to scatter light more efficiently at longer wavelengths, providing robust Mie scattering across the PL emission range of all three phosphors.

Electric field enhancement at the emission peaks of phosphors surrounding SiO₂ microspheres of different sizes is shown in FIG. 5B under the excitation of a horizontal emission dipole. These results indicate significant field modification by the SiO₂ microspheres, demonstrating their capacity to modulate the PL process of the phosphors. FIG. 5C further shows colored microsized fluorescent particles mixed with SiO₂ microspheres of varying diameters. To quantify the impact, the PL lifetimes of phosphors in coatings with SiO₂ microspheres of different average diameters were characterized. As shown in FIG. 5D-5E, the PL lifetimes of all phosphors in the coating are noticeably reduced. Notably, the PL emission spectra of Sr₂Si₅N₈:Eu²⁺ and (Ba,Sr)SiO₄:Eu²⁺ can be deconvoluted into two peaks, corresponding to Eu²⁺ ions experiencing distinct crystal fields. However, as the monitoring wavelength lies in the overlapping region of the two emission peaks, a single exponential form is used for lifetime fitting.

The reduction in PL lifetime caused by surrounding SiO₂ microspheres accelerates the release of electrons from the excited energy levels, increasing competition with non-radiative decay processes. This enhancement improves the photoluminescence quantum yield (PLQY) via the Purcell effect. Additionally, the reduced electron population in the excited energy state allows more incident photons to be absorbed, facilitating further excitation. To evaluate the impact of the Purcell effect on the PL properties of phosphors integrated into the coating, the absorption of excitation light (Abs), photoluminescence quantum yield (PLQY), and power yield (PY) are defined as follows:

$$Abs = {\int }_{{λ}_{ex , min}}^{{λ}_{ex , max}} h c \frac{{I}_{ref} ( λ ) - {I}_{PL} ( λ )}{λ {I}_{ref} ( λ )} \qquad ( 1 )$$

$$PLQY = \frac{{\int }_{{λ}_{em , min}}^{{λ}_{em , max}} {I}_{PL} ( λ ) - {I}_{ref} ( λ )}{{\int }_{{λ}_{ex , min}}^{{λ}_{ex , max}} {I}_{ref} ( λ ) - {I}_{PL} ( λ )} \qquad ( 2 )$$

$$PY = \frac{{\int }_{{λ}_{em , min}}^{{λ}_{em , max}} h c \frac{{I}_{PL} ( λ ) - {I}_{ref} ( λ )}{λ}}{{\int }_{{λ}_{ex , min}}^{{λ}_{ex , max}} h c \frac{{I}_{ref} ( λ ) - {I}_{PL} ( λ )}{λ}} \qquad ( 3 )$$

where λ_{ex,min}˜λ_{ex,max} and λ_{em,min}˜λ_{em,max} are the wavelength range of excitation and emission of phosphors, respectively. I_{PL}(λ) and I_{ref}(λ) are the measured photon intensity with and without samples, respectively. h and c are Planck's constant and the speed of light, respectively.

### Example 2. Evaluating the Photoluminescence and Cooling Efficiency of the Fluorescent Radiative Cooling Coatings

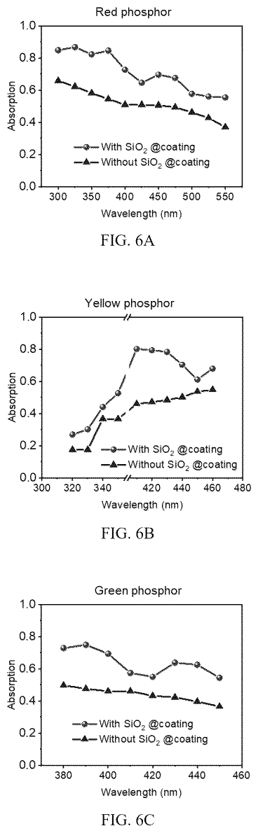

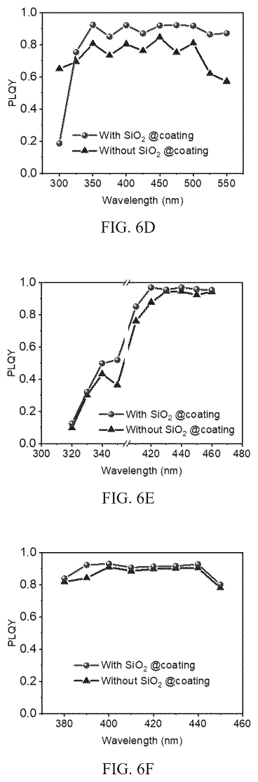

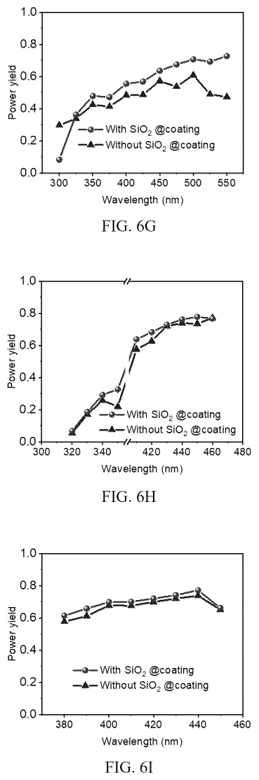

To evaluate the effect of SiO₂ microspheres on the photoluminescence (PL) behavior within the coating, a control group is prepared using a top layer containing only phosphors in a polymer matrix. SiO₂ microspheres with an average diameter of 5 μm, identified as optimal for the Purcell effect (FIG. 5), are incorporated into the experimental group. Results show significant increases in excitation light absorption (Abs): 13-25% for red phosphors, 8-26% for yellow, and 7-22% for green (FIG. 6A-6C). This enhancement is attributed to the spherical Mie resonators' multiple scattering, effectively redirecting light to the phosphors. The PL quantum yields (PLQYs) also improve, with red phosphors experiencing over a 10% average enhancement due to reduced non-radiative decay, while yellow and green phosphors show smaller gains due to their already high PLQYs (FIG. 6D-6F).

This increased PLQY, coupled with better absorption, allows more sunlight to be converted into long-wavelength photons, minimizing light-to-heat conversion. Power yield (PY), representing photon energy efficiency, exhibits similar trends, with all phosphors achieving over 40% under SiO₂ enhancement (FIG. 6G-6I). This demonstrates effective solar energy conversion and improved sub-ambient cooling performance, while maintaining vivid coloration.

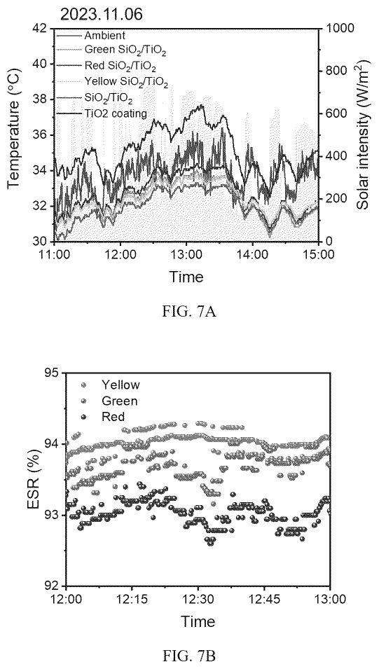

Field tests under typical winter clear skies in Hong Kong demonstrate the coatings' practical cooling capabilities. Colored bilayer coatings, fabricated with a TiO₂-based bottom layer and fluorescent top layers, achieve surface temperature reductions of 1.5° C. (red), 1.2° C. (yellow), and 0.8° C. (green) compared to ambient air, while the white bilayer coating reduces temperatures by up to 2° C. In contrast, a base TiO₂ coating without a fluorescent layer show temperature approximately 1.8° C. above ambient (FIG. 7A). The yellow coating exhibits the best performance, attributed to its smallest Stokes shift (95 nm) and highest PLQY (FIG. 2B, 6E). The effective solar reflectance of all coatings is fitted by the solar reflectance-temperature relations among all non-fluorescent coatings as:

$$T = a \cdot ESR + b \qquad ( 4 )$$

where a and b are environmental parameters fitted from the solar reflectance as well as the temperature of white base (TiO₂ bottom) and white bilayer coatings.

Effective solar reflectance (ESR) values for red, yellow, and green coatings are calculated as 93%, 94%, and 93.6%, respectively (FIG. 7B). These correspond to potential cooling powers of 38.1 W/m², 45.6 W/m², and 42.6 W/m². Red coatings show slightly lower ESR due to a larger Stokes shift and lower PLQY, yet still demonstrate significant cooling performance. The Purcell-enhanced fluorescent strategy effectively introduces vibrant colors without sacrificing solar reflectance, offering an innovative solution for energy-efficient, aesthetically appealing radiative cooling applications.

### Example 3. Characteristics of a Blue-Colored Radiative Cooling Coating

To develop an efficient blue-colored radiative cooling coating, a bilayer structure is utilized, comprising a super-white bottom layer for optimal solar reflection and a thin top layer for coloration while minimizing near-infrared (NIR) absorption. The bottom layer is designed using nanoparticles with a high refractive index to enhance light scattering, providing superior solar reflectance. Zirconium dioxide (ZrO₂) is selected as the scattering material due to its high refractive index (˜2.2) and wide band gap (5-7 eV), which prevents UV absorption.

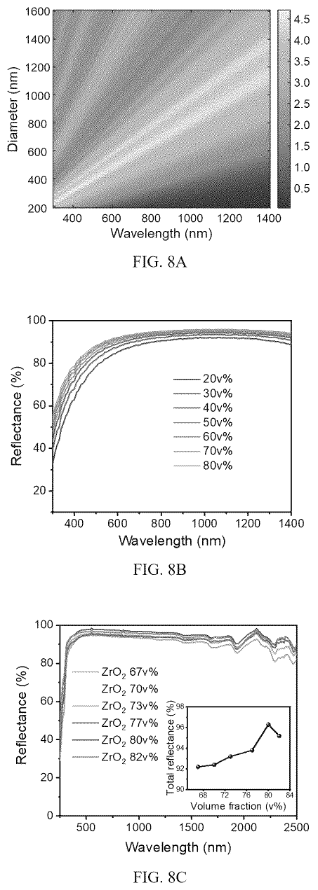

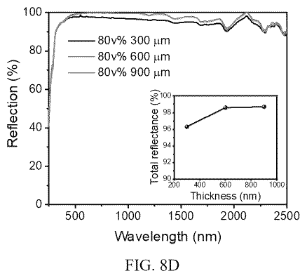

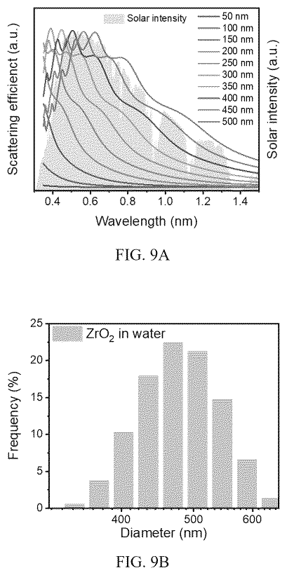

FIG. 8A illustrates the calculated scattering efficiency of ZrO₂ nanoparticles with varying diameters embedded in a polymer matrix, revealing that larger nanoparticle scatters light more effectively at longer wavelengths. Experimental measurements, as shown in FIG. 9A, confirm that ZrO₂ nanoparticles with a diameter of ˜500 nm achieve peak scattering efficiency in the 500-1000 nm range, covering the energy-intensive portion of the solar spectrum.

The size distribution of dispersed ZrO₂ nanoparticles in water is measured, yielding an average diameter of approximately 480 nm (FIG. 9B). Using a Monte Carlo method, the reflectance spectra of coatings with different ZrO₂ volume fractions are calculated. Results (FIG. 8B) indicate that reflectance increases with volume fraction, plateauing at 80v %. Guided by these results, coatings with ZrO₂ volume fractions of 67v % to 82v % (for instance, 67v %, 70v %, 73v %, 77v %, 80v % and 82v %) are fabricated and evaluated experimentally, showing trends consistent with the calculations (FIG. 8C). At 80v % volume fraction, the solar reflectance stabilizes at ˜98.7% for coatings exceeding 600 nm thickness (FIG. 8D).

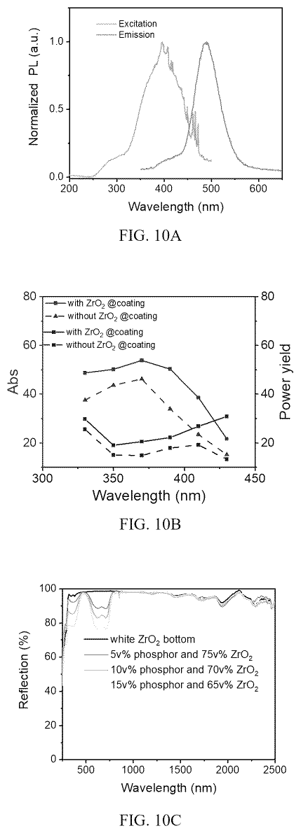

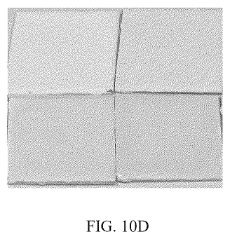

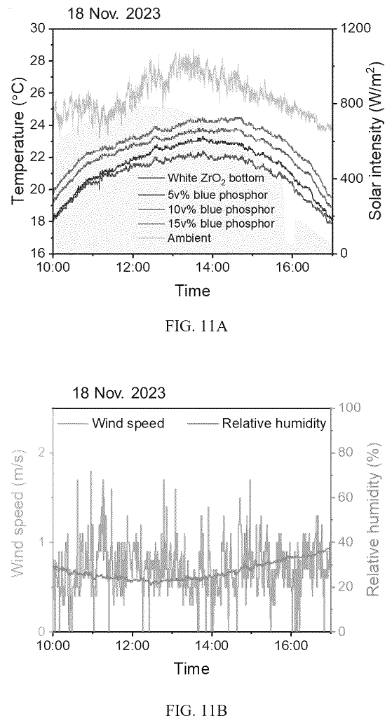

For the top layer, the blue phosphor SrO·Al₂O₃:Eu is employed as the fluorescent material. FIG. 10A presents its excitation and emission spectra, demonstrating excitation around 400 nm and emission at longer wavelengths. The phosphor's small Stokes shift (˜100 nm) indicates minimal energy loss during the photoluminescence (PL) process. Although the direct emission power intensity of the phosphor is lower than reflected sunlight, its PL properties are enhanced via the Purcell effect. As shown in FIG. 10B, the absorption of excitation light increases by 6.5-16.3% due to electric field modification by ZrO₂ nanoparticles, while the power yield improves by 4.0-17.6%. These enhancements enable more efficient conversion of absorbed light into longer wavelengths, improving the coating's color intensity.

A bilayer blue coating is fabricated, combining an ultra-white bottom layer with a 25 nm top layer containing varied blue phosphor volume fractions (5v %, 10v %, and 15v %). All coatings maintained a total solid volume fraction of 80v % to prevent cracking. As shown in FIG. 10C and Table 1, the reflectance of the white coating and the unexcited fluorescent blue coatings is 97.6%, 94.1%, 91.5% and 88%, respectively. The reflectance exhibits a progressive decline in reflectivity with increased blue phosphor concentration, a phenomenon attributable to the intrinsic light absorption of the phosphor. Photos of the resulting coatings (FIG. 10D) display progressively deeper blue hues with increasing phosphor content.

TABLE 1
Reflectance of white bottom and unexcited bilayer blue coatings

| Sample | UV | Vis | NIR | Total |
|---|---|---|---|---|
| White ZrO₂ bottom | 96.0% | 98.8% | 98.6% | 98.7% |
| 5v % phosphor and 75v % ZrO₂ | 92.5% | 91.7% | 97.5% | 94.1% |
| 10v % phosphor and 70v % ZrO₂ | 85.7% | 86.5% | 96.9% | 91.5% |
| 15v % phosphor and 65v % ZrO₂ | 77.8% | 80.4% | 96.2% | 88.0% |

In an outdoor field test conducted under clear blue skies in Hong Kong, the cooling performance of bilayer-colored radiative cooling coatings was evaluated. Temperature variations relative to ambient conditions during peak solar intensity around noontime are presented in FIG. 11A. The white bottom layer exhibited a significant cooling effect, reducing surface temperatures by up to 6° C. below ambient levels. Meanwhile, the bilayer blue coatings, which incorporated blue phosphor at concentrations of 5v %, 10v %, and 15v %, demonstrated a gradual decline in cooling efficiency as the phosphor concentration increased. Specifically, the temperature reductions achieved were 5° C., 4.5° C., and 3.7° C. for the respective phosphor concentrations. This reduction in cooling efficiency is attributed to the increased light absorption inherent to the higher phosphor content.

In summary, the fluorescent-assisted colored coatings of the present invention show significant improvements in PLQY and energy conversion efficiency. Moreover, the improved absorption within the excitation range enables potential color manipulation without incurring heat gain. Field tests further demonstrate that higher Purcell factor and SiO₂ with proper diameters are preferred to improve the cooling performance, indicating a feasible solution to maintain solar reflection with coloration.

As used herein, terms “approximately”, “basically”, “substantially”, and “about” are used for describing and explaining a small variation. When being used in combination with an event or circumstance, the term may refer to a case in which the event or circumstance occurs precisely, and a case in which the event or circumstance occurs approximately. As used herein with respect to a given value or range, the term “about” generally means in the range of ±10%, ±5%, ±1%, or ±0.5% of the given value or range. The range may be indicated herein as from one endpoint to another endpoint or between two endpoints. Unless otherwise specified, all the ranges disclosed in the present disclosure include endpoints. When reference is made to “substantially” the same numerical value or characteristic, the term may refer to a value within ±10%, ±5%, ±1%, or ±0.5% of the average of the values.

The foregoing description of the present invention has been provided for the purposes of illustration and description. It is not intended to be exhaustive or to limit the invention to the precise forms disclosed. Many modifications and variations will be apparent to the practitioner skilled in the art.

The embodiments were chosen and described in order to best explain the principles of the invention and its practical application, thereby enabling others skilled in the art to understand the invention for various embodiments and with various modifications that are suited to the particular use contemplated.

1. A colored bilayer sub-ambient radiative cooling coating for improving solar reflectance and coloration, comprising:
a white bottom layer, comprising TiO₂ or ZrO₂ nanoparticles and hollow glass spheres; and
a colored top layer positioned on the white bottom layer, comprising SiO₂ microspheres and fluorescent pigment selected from Sr₂Si₅N₈:Eu²⁺ phosphors, Y₃Al₅O₁₂:Ce³⁺ phosphors, (Ba,Sr)SiO₄:Eu²⁺ phosphors, or SrO·Al₂O₃:Eu phosphors;
wherein the colored bilayer sub-ambient radiative cooling coating achieve an effective solar reflectance of at least 90% and a sub-ambient temperature reduction of at least 3° C. compared to ambient air.

2. The colored bilayer sub-ambient radiative cooling coating of claim 1, wherein the white bottom layer and the colored top layer include a polymer matrix material selected from one or more of poly(styrene-acrylic), poly(methyl methacrylate), poly(vinylidene fluoride), poly(ethylene-co-vinyl acetate), or polycarbonate.

3. The colored bilayer sub-ambient radiative cooling coating of claim 2, wherein the nanoparticles are the TiO₂ nanoparticles when the fluorescent pigments are the Sr₂Si₅N₈:Eu²⁺ phosphors, Y₃Al₅O₁₂:Ce³⁺ phosphors, or (Ba,Sr)SiO₄:Eu²⁺ phosphors.

4. The colored bilayer sub-ambient radiative cooling coating of claim 2, wherein the nanoparticles are the ZrO₂ nanoparticles when the fluorescent pigments are the SrO·Al₂O₃:Eu phosphors.

5. The colored bilayer sub-ambient radiative cooling coating of claim 1, wherein the SiO₂ microspheres in the white bottom layer have diameters ranging from 2 μm to 10 μm to optimize light scattering across the visible spectrum.

6. The colored bilayer sub-ambient radiative cooling coating of claim 1, wherein the top layer has a thickness of 20 μm to 40 μm to balance color intensity and minimize solar absorption.

7. The colored bilayer sub-ambient radiative cooling coating of claim 1, wherein the white bottom layer has a thickness of 300 μm to 900 μm.

8. The colored bilayer sub-ambient radiative cooling coating of claim 1, wherein the fluorescent pigments exhibit a photoluminescence quantum yield (PLQY) of at least 50% under direct sunlight exposure.

9. The colored bilayer sub-ambient radiative cooling coating of claim 1, wherein the coating is configured to provide a cooling power of at least 38 W/m² under peak solar intensity.

10. The colored bilayer sub-ambient radiative cooling coating, wherein the white bottom layer achieves a solar reflectance of at least 95% independently of the colored top layer.

11. A method of fabricating the colored bilayer sub-ambient radiative cooling coating of claim 1 on a substrate, comprising:
preparing a white bottom layer by dispersing TiO₂ or ZrO₂ nanoparticles, SiO₂ microspheres, and hollow glass spheres in a polymer matrix;
depositing the white bottom layer onto a substrate;
preparing a colored top layer by incorporating fluorescent pigments into a polymer matrix; and
layering the colored top layer onto the white bottom layer to form the bilayer coating.

12. The method of claim 11, wherein the fluorescent pigments comprise one or more of Sr₂Si₅N₈:Eu²⁺ phosphors, Y₃A₁₅O₁₂:Ce³⁺ phosphors, (Ba,Sr)SiO₄:Eu²⁺ phosphors, and SrO·Al₂O₃:Eu phosphors.
